(19) United States
(12) Patent Application Publication
(10) Pub. No.: US 2017/0130760 A1
(43) Pub. Date: May 11, 2017

(54) BOLT RETENTION SYSTEM

(71) Applicant: Honda Motor Co., Ltd., Tokyo (JP)

(72) Inventor: Steven R. THIELE, Marysville, OH (US)

(21) Appl. No.: 14/937,650

(22) Filed: Nov. 10, 2015

(51) Int. Cl. F16B 41/00; F16B 39/24

(52) U.S. Cl. CPC F16B 41/002; F16B 39/24

(57) ABSTRACT

A bolt retention system includes a bolt and a receiver. The bolt has a head formed at the end having a radial thickness greater than an adjacent neck and a threaded portion having a plurality of external bolt threads. The receiver has a spring section, a threaded section, and a bracket section. The spring section has a distal end that springs outwardly from a longitudinal axis of the bolt as the head of the bolt passes through the spring section, the distal end of the spring section being biased to maintain contact with the neck of the bolt after the head of the bolt passes through the spring section to create an interference fit with the head of the bolt. The threaded section of the receiver is adapted to receive the threaded portion of the bolt for securing the bolt to the work piece.

### BACKGROUND

The present invention relates to fasteners and, more particularly, to retained panel fastener systems and assemblies.

For certain applications, it is desirable to retain a bolt, pin, or the like in a work piece while providing the ability to hold the bolt in a position where a base of the bolt is held away from the structure in a pre-assembly position.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

A bolt retention system is disclosed that includes a bolt and a receiver. The bolt has an elongated portion adapted to be positioned within an opening of a work piece, the work piece having a first side and a second side opposite the first side, the elongated portion having a first end and a second end opposite the first end, a head formed at the first end, the head having a radial thickness greater than a neck of the bolt located adjacent the head and between the head and the second end, and a threaded portion having a plurality of external bolt threads, the threaded portion being adapted to extend past the second side of the work piece. The receiver has a spring section, a threaded section, and a bracket section, the bracket section having a radial width greater than a radial width of opening of the work piece, the bracket section abutting the second side of the work piece, the spring section having a distal end that springs outwardly from a longitudinal axis of the bolt as the head of the bolt passes through the spring section, the distal end of the spring section being biased to maintain contact with the neck of the bolt after the head of the bolt passes through the spring section to create an interference fit with the head of the bolt, the threaded section of the receiver being adapted to receive the threaded portion of the bolt for securing the bolt to the work piece.

### BRIEF DESCRIPTION OF THE DRAWINGS

FIG. 1 is an exploded perspective view of a bolt retention system.

FIG. 2 is a side view of a cross-section of the bolt retention system of FIG. 1.

FIG. 3 is a side view of a cross-section of the bolt retention system illustrated in FIG. 1 in a preassembly position.

FIG. 4 is a side view of a cross-section of the bolt retention system illustrated in FIG. 1 in a fully tightened position.

FIG. 5 is a side view of a cross-section of the bolt retention system illustrated in FIG. 1 in an untightened position.

The figures depict various embodiments of the embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

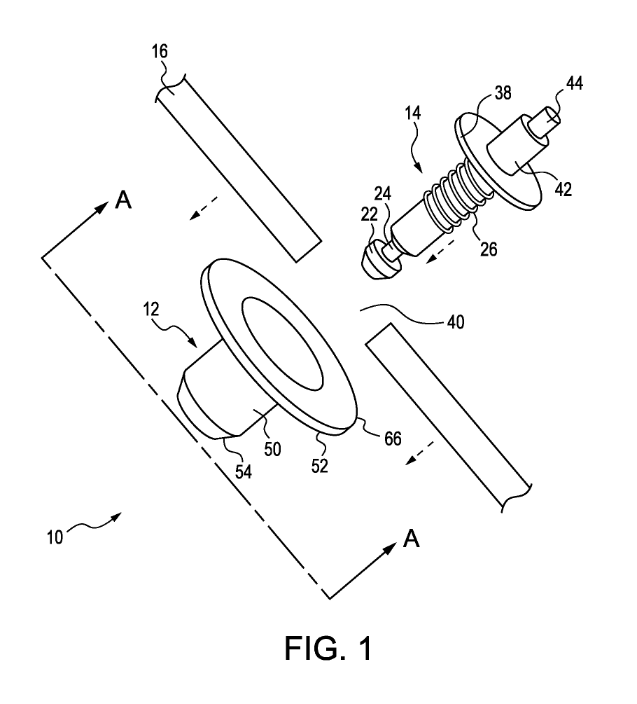

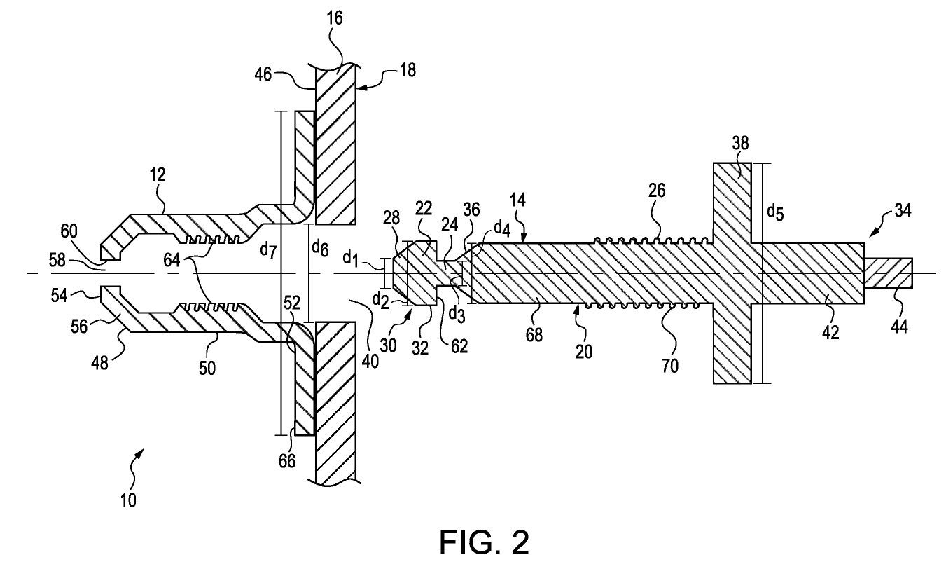

FIGS. 1-5 illustrate an embodiment of a bolt retention system 10. The bolt retention system 10 illustrated is used in a motor vehicle, primarily the sliding door of a minivan, although the bolt retention system 10 may be used in any application or manor recognized by one skilled in the art. In particular, FIG. 1 is an exploded perspective view of the bolt retention system 10, and FIGS. 2-5 are side view cross sections along line A-A that bisects the view of FIG. 1 in various assembly stages of the bolt retention system.

As illustrated in FIGS. 1-5, the bolt retention system 10 includes a receiver 12 and a bolt 14. The bolt 14 is positioned on a first side 18 of a work piece 16, such as a body panel. The bolt 14 includes an elongated portion 20 that has a head 22, a neck 24, and a threaded portion 26. In one embodiment, the work piece 16 may be a single piece. In another embodiment, the work piece 16 may be two pieces being connected together.

The head 22 of the bolt 14 has a sloped surface 28 that allows the head 22 of the bolt 14 to be inserted into the receiver 12. The sloped surface 28 gradually extends radially outwardly from the first end 30 of the bolt 14, with the smallest radial diameter d₁ being at the first end 30 of the bolt 14, until a maximum head radial diameter d₂ is achieved at a portion 32 located longitudinally toward the second end 34 of the bolt 14. Adjacent to the head 22 of the bolt 14 in the longitudinal direction is a neck 24 of the bolt 14. The neck 24 has a radial diameter d₃ that is less than the maximum head radial diameter d₂ of the head 22. In the embodiment illustrated in FIG. 1-5, the transition from the head 22 to the neck 24 is immediate at a 90° angle.

Located adjacent to the neck 24 of the bolt 14 is a threaded portion 26. The threaded portion 26 has a radial diameter d₄ that is greater than the radial diameter d₃ of the neck 24. In the embodiment shown, the radial diameter d₄ of the threaded portion 26 is the same as the maximum head radial diameter d₂ of the head 22. The threaded portion 26 also includes a second sloped surface 36 that gradually transitions from the radial diameter d₃ of the neck 24 to the radial diameter d₄ of the threaded portion 26.

At the second end 34 of the bolt 14 is a base section 38. The base section 38 extends outwardly in a radial direction. The radial diameter d₅ of the base section 38 should be greater than the diameter d₆ of the opening 40 in the work piece 16.

Additionally, in the embodiment shown in the FIG. 1, the bolt 14 may have a pin 42 extending longitudinally from the second end 34 of the bolt 14. The pin 42 may additionally include a torque head 44 for receiving a torque wrench used to tighten and loosen the bolt 14. Alternatively, the base section 38 of the bolt 14 may be hexagonally shaped in the radial direction to engage a wrench for tightening and loosening the bolt 14.

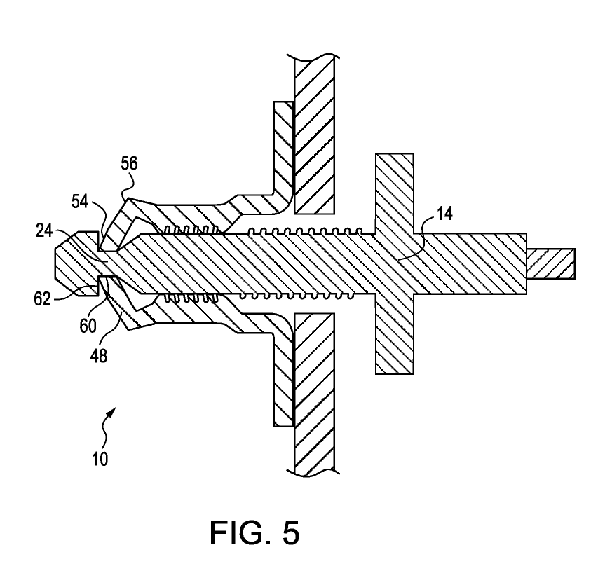

The receiver 12, as illustrated in FIGS. 1-5, is positioned on the second side 46 of the work piece 16. The receiver 12 has a spring section 48, a threaded section 50, and a bracket section 52. The spring section 48 has a distal end 54 and a flexible body 56 that are made of a flexible material, such a plastic or any other suitable material known to those skilled in the art. In a home position, the distal end 54 of the spring section 48 includes an opening 58 that includes a lip 60. As the head 22 is introduced into the opening 58, the sloped surface 28 of the head 22 gradually dilates the opening 58, thereby allowing the bolt 14 to pass through the opening 58. After the head 22 of the bolt 14 clears the opening 58 and the distal end 54, the spring section 48 is biased to return to the home position, and the lip 60 surrounding the opening 58 in the distal end 54 engages the neck 24 of the bolt 14. The 90° transition from the head 22 to the neck 24 creates an interference surface 62 on the bolt 14 that abuts the lip 60 of the distal end 54, thereby creating an interference fit that prevents removal of the bolt 14 from the receiver 12. The interference surface 62 prevents the bolt 14 from dilating the opening 58 in the distal end 54 if an operator attempts to remove the bolt 14. As illustrated in FIG. 5, the flexible body 56 of the spring section 48 may bend outwardly in a radial direction if removal of the bolt 14 is attempted, but the lip 60 of the distal end 54 remains engaged with the neck 24 and interference surface 62 of the neck 24 to prevent removal of the bolt 14.

With continuing reference to FIGS. 1-5, the threaded portion 50 of the receiver 12 is relatively non-flexible and includes a number of internal facing threads 64 meant to receive the threaded portion 26 of the bolt 14 when the bolt 14 is tightened. The bracket section 52 of the receiver 12 is opposite the distal end 54 in a longitudinal direction of the receiver 12. The bracket section 52 includes a radially extending flange 66 that engages a second side 46 of the work piece 16 opposite the first side 18 that engages by the base section 38 of the bolt 14. The radial diameter d₇ of the flange 66 is greater than the radial diameter d₆ of the opening 40 in the work piece 16.

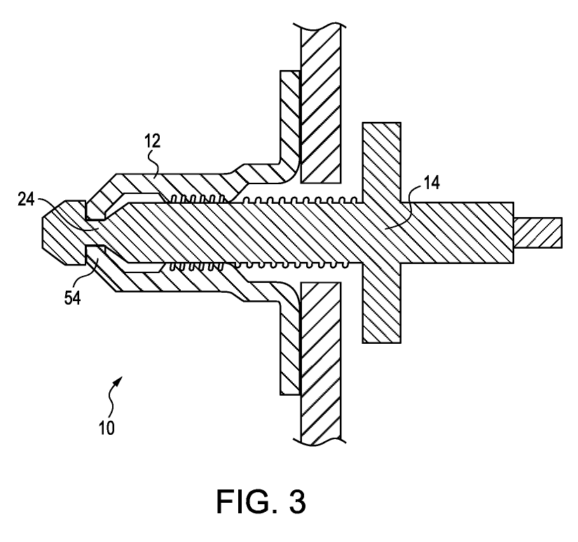

In the embodiment shown in FIG. 3, the distal end 54 is engaged with the neck 24 of the bolt 14 in a pre-assembly position. While in this position, the bolt 14 in not in a final tightened state, but it is captured and held by the receiver 12 in a non-removable position.

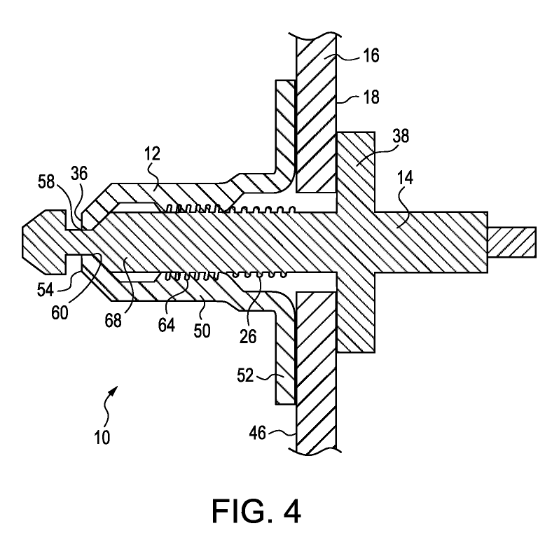

With reference to FIG. 4, in order to be finally tightened to secure the work piece 16, the bolt 14 is turned so that the threaded portion 26 engages the threaded section 50 of the bolt 14. In the embodiment illustrated, when the bolt 14 is tightened so that the base section 38 is tightly secured to the first side 18 of the work piece 16 and the bracket section 52 of the receiver 12 is tightly secured to the second side 46 of the work piece 16. The threads 64 on the threaded section 50 of the receiver 12 are fully engaged by the threaded section 26 of the bolt 14. In the fully tightened position, the second sloped surface 36 is pushed through a dilated opening 58 in the distal end 54 and the lip 60 of the distal end 54 rests against the threaded portion 26 in a region 68 of the threaded portion 26 without threads. In an alternate embodiment, the threaded portion 26 may be completely threaded, and, in that case, the lip 60 of the distal end 54 would rest against threads 70 of the bolt 14 that have moved past the threaded section 50 of the receiver 12.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A bolt retention system, comprising:
a bolt having an elongated portion adapted to be positioned within an opening of a work piece, the work piece having a first side and a second side opposite the first side, the elongated portion having a first end and a second end opposite the first end, a head formed at the first end, the head having a radial thickness greater than a neck of the bolt located adjacent the head and between the head and the second end, a threaded portion having a plurality of external bolt threads, the threaded portion being adapted to extend past the second side of the work piece; and
a receiver having a spring section, a threaded section, and a bracket section, the bracket section having a radial width greater than a radial width of opening of the work piece, the bracket section abutting the second side of the work piece, the spring section having a distal end that springs outwardly from a longitudinal axis of the bolt as the head of the bolt passes through the spring section, the distal end of the spring section being biased to maintain contact with the neck of the bolt after the head of the bolt passes through the spring section to create an interference fit with the head of the bolt, the threaded section of the receiver being adapted to receive the threaded portion of the bolt for securing the bolt to the work piece.

2. The bolt retention system of claim 1 wherein the bolt further comprises a base section, the base section located at the second end of the elongated portion, the base section having radial width greater than a radial width of opening of the work piece, the base section abutting the first side of the work piece when tightened.

3. The bolt retention system of claim 2 wherein the base section further comprises a pin extending along a longitudinal axis of the bolt away from the work piece.

4. The bolt retention system of claim 3 wherein the base section further comprises an external torque head for tightening the bolt, the external torque head extending from the pin along the longitudinal axis of the bolt away from the work piece.

5. The bolt retention system of claim 1 wherein the spring section of the receiver bends to maintain contact with the neck of the bolt if an attempt is made to remove the bolt from the receiver.
